(19) United States
(12) Patent Application Publication
(10) Pub. No.: US 2017/0108292 A1
(43) Pub. Date: Apr. 20, 2017

(54) Connector For Condenser Header Tank

(71) Applicant: DENSO International America, Inc., Southfield, MI (US)

(72) Inventor: Kevin GRASL, Sterling Heights, MI (US)

(21) Appl. No.: 14/886,546

(22) Filed: Oct. 19, 2015

(51) Int. Cl. F28F 9/02; F25B 41/00; F16L 41/08; F25B 39/00

(52) U.S. Cl. CPC F28F 9/0253; F25B 39/00; F25B 41/003; F28F 9/0256; F16L 41/086; F25B 39/04

(57) ABSTRACT

An HVAC refrigerant line connector for a condenser header tank. The connector includes a header tank mating surface having a concave shape configured to mate with a convex outer tank surface of the condenser header tank. An outer surface is opposite to the header tank mating surface. A first through bore is defined by the connector extending between the outer surface and the header tank mating surface. A first channel is defined by the header tank mating surface. The first channel is configured to receive header tank material staked into the first channel to hold the header tank mating surface against the convex outer tank surface prior to the connector being brazed to the header tank.

### FIELD

The present disclosure relates to a connector for a condenser header tank, such as a refrigerant line connector.

### BACKGROUND

This section provides background information related to the present disclosure, which is not necessarily prior art.

Heating, ventilation and air conditioning (HVAC) systems typically include a condenser and a connector for connecting HVAC refrigerant lines to a header tank of the condenser. The connector is often connected to the header tank by brazing. While current connectors are suitable for their intended use, they are subject to improvement. For example, current connectors fail to provide enough brazing surface to resist high torques that may be exerted upon the connector, which may result in the connector becoming detached from the header tank. The present teachings address these and other shortcomings experienced in the prior art.

### SUMMARY

This section provides a general summary of the present teachings, and is not a comprehensive disclosure of its full scope or all of its features.

The present teachings provide for an HVAC refrigerant line connector for a condenser header tank. The connector includes a header tank mating surface having a concave shape configured to mate with a convex outer tank surface of the condenser header tank. An outer surface is opposite to the header tank mating surface. A first through bore is defined by the connector extending between the outer surface and the header tank mating surface. A first channel is defined by the header tank mating surface. The first channel is configured to receive header tank material staked into the first channel to hold the header tank mating surface against the convex outer tank surface prior to the connector being brazed to the header tank.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an HVAC refrigerant line connector according to the present teachings mounted to a header tank of a condenser;

FIG. 2 illustrates the HVAC refrigerant line connector of FIG. 1 separated from the header tank;

FIG. 3 is a perspective view of the HVAC refrigerant line connector of FIG. 1;

FIG. 4 is a cross-sectional view taken along line 4-4 of FIG. 3;

FIG. 5 is a side view of the HVAC refrigerant line connector of FIG. 1 spaced apart from the header tank prior to being connected thereto; and

FIG. 6 is a side view of the HVAC refrigerant line connector coupled to the header tank of the condenser.

Corresponding reference numerals indicate corresponding parts throughout the several views of the drawings.

### DETAILED DESCRIPTION

Example embodiments will now be described more fully with reference to the accompanying drawings.

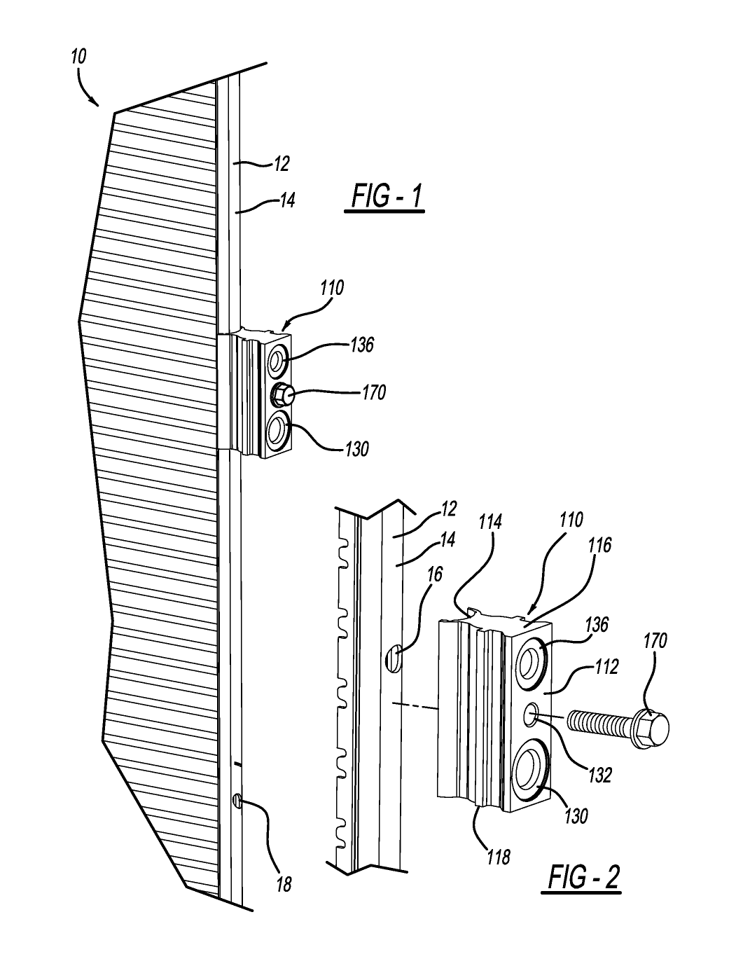

FIG. 1 illustrates an HVAC condenser at reference numeral 10. The condenser 10 includes a header tank 12 having an outer tank surface 14. Mounted to the outer tank surface 14 is an HVAC refrigerant line connector 110 according to the present teachings. As illustrated in FIG. 2, the connector 110 is mounted over a first tank aperture 16 defined by the outer tank surface 14. The first tank aperture 16 can be an inlet or outlet for the introduction of HVAC refrigerant into or out of the header tank 12, as further described herein.

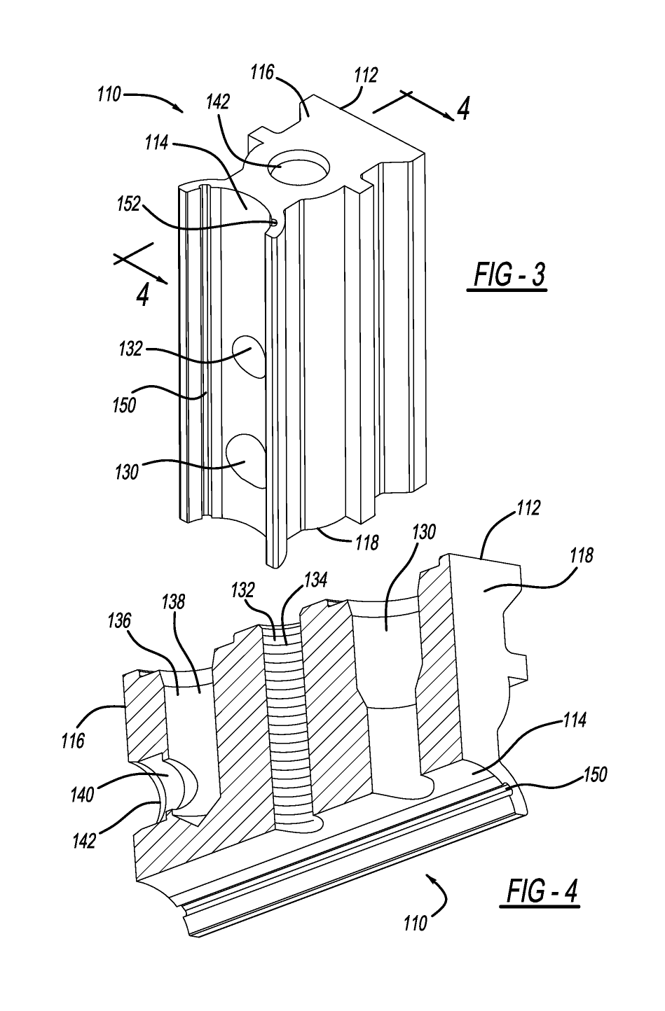

With continued reference to FIGS. 1 and 2, and additional reference to FIGS. 3 and 4, the HVAC refrigerant line connector 110 according to the present teachings will now be described further. The connector 110 generally includes an outer surface 112, which is opposite to a header tank mating surface 114. Extending between the outer surface 112 and the header tank mating surface 114 at opposite ends of the connector 110 is a first side surface 116 and a second side surface 118. The header tank mating surface 114 is curved and has a concave shape that corresponds to the outer tank surface 14, which generally has a convex shape. The concave header tank mating surface 114 of the connector 110 is shaped to correspond to and receive the outer tank surface 14, and provides a brazing surface of the connector 110. The header tank mating surface 114 provides the connector 110 with a brazing surface that is substantially larger than existing connectors, thereby allowing the connector 110 to be more securely coupled to the header tank 12.

The connector 110 defines a first through bore 130 and a second through bore 132, each of which extends from the outer surface 112 to the header tank mating surface 114. The first through bore 130 is configured to receive, or mate with in any suitable manner, a refrigerant line of an HVAC system configured to deliver refrigerant to the connector 110, or direct refrigerant away from the connector 110. Thus by way of the first through bore 130, which is aligned with the first tank aperture 16 when the connector 110 is coupled to the header tank 12, HVAC refrigerant can be introduced into, or directed away from, the connector 110. Therefore, the connector 110 can be an inlet connector or an outlet connector. As an inlet connector, the connector 110 will be mounted over the first tank aperture 16 configured as an inlet aperture. As an outlet connector, the connector 110 will be mounted over the first tank aperture 16 configured as an outlet aperture.

The second through bore 132 is configured to receive a fastener 170. The fastener 170 can be configured to secure an additional connector (not shown) to the connector 110. The additional connector can be configured to couple inlet and outlet refrigerant pipes to the connector 110. The second through bore 132 can include threads 134 configured to threadably cooperate with threads of the fastener 170 when the fastener 170 is a threaded fastener.

The connector 110 can further include a third through bore 136, which includes a first portion 138 and a second portion 140 (see FIG. 4). The first portion 138 extends from the outer surface 112 into the connector 110. The second portion 140 extends from the first portion 138 to a side aperture 142 defined by the first side surface 116. Thus the first portion 138 and the second portion 140 extend generally perpendicular to one another. The third through bore 136 can be configured to receive refrigerant that has been circulated through the condenser 10, and direct the refrigerant to a refrigerant pipe extending away from the connector 110. Specifically, side aperture 142 can be in fluid communication with a pipe or other conduit extending to a connector (not shown), which can be similar to the connector 110, coupled to the header tank 12 at a second tank aperture 18, which is illustrated in FIG. 1. Refrigerant that has been circulated through the condenser 10 exits through the second tank aperture 18, flows through the connector (not shown) mounted at the second tank aperture 18, and through the pipe extending to the connector 110. The refrigerant enters the third through bore 136 through the side aperture 142 and exits through the first portion 138. The header tank mating surface 114 defines a first channel 150 and a second channel 152 extending lengthwise across the header tank mating surface 114 on opposite sides of the first and second through bores 130 and 132. The first and second channels 150 and 152 can extend parallel to one another as illustrated.

The HVAC refrigerant line connector 110 can be made of any suitable material. For example, the connector 110 can be made of any suitable metallic material, such as aluminum. The header tank 12 is also often made of aluminum.

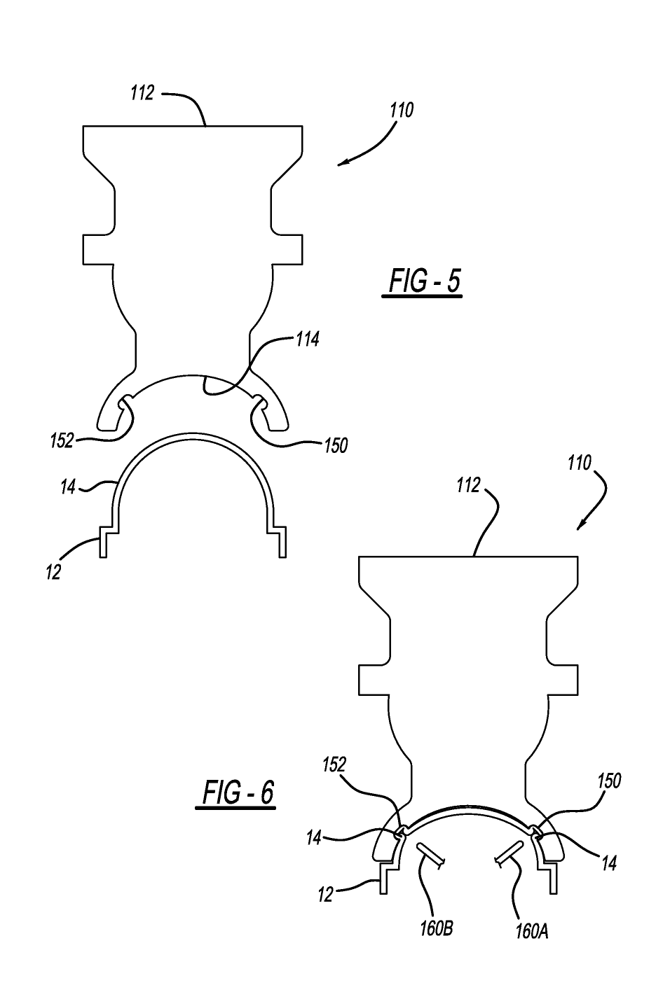

With continued reference to FIGS. 1 through 4, and additional reference to FIGS. 5 and 6, mounting of the HVAC refrigerant line connector 110 to the header tank 12 will now be described. With particular reference to FIG. 5, the connector 110 is arranged such that the header tank mating surface 114 is opposite to the outer tank surface 14 of the header tank 12. The connector 110 is then pressed against the header tank 12 such that an entirety of, or generally an entirety of, the mating surface 114 abuts the outer tank surface 14.

With particular reference to FIG. 6, the outer tank surface 14 is then staked (or caulked) into the first and second channels 150 and 152 using any suitable staking tool, which is generally illustrated at 160A and 160B. With the outer tank surface 14 staked within the first and second channels 150 and 152 as illustrated in FIG. 6, the connector 110 is held against the header tank 12 to facilitate brazing of the header tank mating surface 114 of the connector 110 to the outer tank surface 14. The header tank mating surface 114 of the connector 110 and the outer tank surface 14 can be brazed together using any suitable brazing technique. Alternatively, the header tank mating surface 114 can be coupled to the outer tank surface 14 in any other suitable manner in addition to, or apart from, brazing.

The HVAC refrigerant line connector 110 advantageously provides an enlarged brazing surface at the header tank mating surface 114 of the connector 110, thereby providing a connection between the connector 110 and the header tank 12 that is stronger than, and more resistant, to high torque, as compared to existing connectors. Also, the first and second channels 150 and 152 allow for the connector 110 to be coupled to the header tank 12 prior to brazing in order to facilitate the brazing process. One skilled in the art will recognize that the present teachings provide for numerous additional advantages in addition to those specifically set forth herein.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used in this application is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An HVAC refrigerant line connector for a condenser header tank comprising:
a header tank mating surface having a concave shape configured to mate with a convex outer tank surface of the condenser header tank;
an outer surface opposite to the header tank mating surface;
a first through bore defined by the connector extending between the outer surface and the header tank mating surface; and
a first channel defined by the header tank mating surface, the first channel configured to receive header tank material staked into the first channel to hold the header tank mating surface against the convex outer tank surface prior to the connector being brazed to the header tank.

2. The connector of claim 1, wherein the concave shape of the header tank mating surface is complementary to the convex outer tank surface of the condenser header tank.

3. The connector of claim 1, wherein the connector is made of aluminum.

4. The connector of claim 1, further comprising a second through bore defined by the connector extending between the outer surface and the header tank mating surface, the second through bore is spaced apart from the first through bore and extends parallel to the first through bore.

5. The connector of claim 4, wherein:
the first through bore is configured to be in fluid communication with a refrigerant line of an HVAC system to conduct refrigerant therethrough; and
the second through bore is configured to receive a fastener.

6. The connector of claim 5, wherein the second through bore is threaded to cooperate with a threaded fastener.

7. The connector of claim 1, wherein the first channel extends along a length of the header tank mating surface.

8. The connector of claim 1, further comprising a second channel defined by the header tank mating surface, the second channel is configured to receive header tank material staked into the second channel to hold the header tank mating surface against the convex outer tank surface prior to the connector being brazed to the header tank.

9. The connector of claim 8, wherein the first channel extends parallel to the second channel.

10. The connector of claim 8, wherein the first channel and the second channel are on opposite sides of the first through bore.

11. An HVAC refrigerant line connector for a condenser header tank comprising:
a header tank mating surface having a concave shape configured to mate with a convex outer tank surface of the condenser header tank, the concave shape of the header tank mating surface is complementary to the convex outer tank surface of the condenser header tank;
an outer surface opposite to the header tank mating surface;
a first through bore defined by the connector extending between the outer surface and the header tank mating surface, the first through bore is configured to be in fluid communication with a refrigerant line of an HVAC system to conduct refrigerant therethrough;
a second through bore defined by the connector extending between the outer surface and the header tank mating surface, the second through bore is spaced apart from the first through bore and extends parallel to the first through bore, the second through bore is configured to receive a fastener;
a first channel and a second channel both defined by the header tank mating surface on opposite sides of the first and second through bores, each one of the first channel and the second channel is configured to receive header tank material staked therein in order to hold the header tank mating surface against the convex outer tank surface prior to the connector being brazed to the header tank;
wherein the connector is made of a metallic material.

12. The connector of claim 11, wherein the second through bore is threaded to cooperate with a threaded fastener.

13. The connector of claim 11, wherein each one of the first and second channels extends along a length of the header tank mating surface.

14. The connector of claim 11, wherein the first and second channels extend in parallel.

15. A method for attaching an HVAC refrigerant line connector to a condenser header tank comprising:
positioning the connector such that a header tank mating surface thereof having a concave shape abuts and mates with a convex outer tank surface of the condenser header tank;
staking material of the header tank into first and second spaced apart channels defined by the header tank mating surface to hold the connector and the header tank mating surface thereof against the convex outer tank surface; and
brazing the connector to the header tank.

16. The method of claim 15, further comprising staking the material of the header tank into the first and second spaced apart channels with a staking tool.

17. The method of claim 15, further comprising mating a refrigerant line of an HVAC system with a first through bore defined by the connector, the first through bore extending between the header tank mating surface and an outer surface opposite to the header tank mating surface.

18. The method of claim 15, further comprising inserting a fastener through a second through bore defined by the connector, the second through bore extending between the header tank mating surface and an outer surface opposite to the header tank mating surface.

19. The method of claim 15, further comprising using a staking tool to stake material of the header tank into the first and second spaced apart channels.
